(19) United States
(12) Patent Application Publication
(10) Pub. No.: US 2015/0248469 A1
(43) Pub. Date: Sep. 3, 2015

(54) System and Method for knowledge discovery information retrieval and information management via tag dimensionalization and proxy archetypes

(71) Applicant: Robert Michael Hust, Coeur dAlene, ID (US)

(72) Inventor: Robert Michael Hust, Coeur dAlene, ID (US)

(73) Assignee: STUDIO BERTO HUSTE, Hayden, ID (US)

(21) Appl. No.: 14/194,816

(22) Filed: Mar. 2, 2014

(51) Int. Cl. G06F 17/30

(52) U.S. Cl. CPC G06F 17/30598

(57) ABSTRACT

This invention describes a system and method for creating analyzing, and comparing proxy representations of persons, places, things, concepts, and constructs for purposes of knowledge management, knowledge discovery, and information retrieval. To facilitate the system an archetype is created that contains a list of words and or phrase descriptors of the object represented by the proxy, an additional list of draws to the proxy consisting of words or phrases describing objects that have a positive affinity with the object being described by the proxy, and an additional list of distances to the proxy consisting of words or phrases describing objects that have a negative affinity with the object being described by the proxy. Both draws and distances may be assigned an amplitude, such that the feature space described by the archetype becomes dimensionalized.

The invention of this method involves no Federal, or publicly sponsored research.

### BACKGROUND OF THE INVENTION

1. Field of Invention

This invention relates to knowledge discovery and information retrieval and information management.

2. Prior Art

In the past, information about particular topics has been marked with meta-data called “tags” to assist in information retrieval and to organize data as a “type”. These tags can be generally thought of as a bag-of-features and are stored either as meta-data within a document itself, or within a database whereby the tags are ascribed by some means to the document. A practice follows that an item with a particular tag is by some means related to any other item with the same tag. Some systems are sophisticated enough to calculate similarity based on the number of tags that are in common between a number of items—the greater the number of common tags, the more similarity there is between the individual representations of data within the collection of data. This practice breaks down when a collection has either too few or too many tags. With too few tags, similarities between documents become less meaningful and less valuable unless the tags have been assigned simply as categories, which limits their use within the system. Information retrieved using sparse tags, unless the tags were simply assigned to ascribe a category, is generally of a lower matching quality than a regular expression query against the body of the document. When sets of data are compared that use too many tags or embody too many tags in a query, the value of the result is also degraded. When comparing a set of documents based on a large number of common tags, the collection of data or documents that are returned are often of too broad an interest. This can be refined by using the tags to construct a filter or a complex query, but many systems, particularly those systems on the Internet, are not constructed in a manner that allows for such queries by the end user or the use of complex filters. We refer to these systems as being one dimensional. The system we propose, the object of this invention, offers significantly better information retrieval and calculations of similarity and context by improving upon how tags are used, stored, and evaluated within a system.

Within the current practice, tags are not assigned a value or amplitude. This means that a document, article, file, etc., tagged with “cheese” is of equal value to any other article such item tagged with “cheese.” Our invention allows for tags to be given a weight or value. The value indicates that a particular tag is more important the another tag. As in the case above, where two items were tagged with “cheese”, but wherein our system is employed, the tags can have an inherent value or weight either assigned them or ascribed through language processing, that allows them to be further evaluated and likely yields a ranking. That means that while each article was tagged with “cheese,” the system can tell which Item is “cheesier.” This advancement greatly improves knowledge discovery and information retrieval, within systems capable of employing a tag cloud, by dimensionalizing the feature space with amplitude. The practice is further improved by storing the tags or ascribed features within a data-structure that can be easily read as a kernel matrix. Such matrices allow the attached articles to be evaluated with any number of kernel methods, and to be easily utilized by vector machines for knowledge discovery. The tags, amplitudes and resulting matrix can further be used as a proxy representation of any physical thing. Such a proxy allows an article to function within a system, as if it were aware of its own context and value amongst any number of such proxies. Furthermore, unlike current systems where the tags are simply stored and evaluated as a bag-of-features, our invention allows for a means of minimizing tags by assigning a token to commonly occurring collections of tags. This enhancement too, speeds information retrieval and comparison.

Common within the information retrieval space is concept of stop words. Stop words tell a query that it should not return answers that contain a particular word or phrase. This word or phrase is a stop word. Sophisticated tagging systems also allow for stop words in queries, but not within the tags themselves. Our invention enhances the value of stop words by allowing them, in essence, to be used as tags and assigning a negative amplitude or weight. This is of value when comparing sets of data because items that have an equal negative weight related to a particular tag or feature, have a high likelihood of positive similarity.

### OBJECTS AND ADVANTAGES

Accordingly, several objects and advantages of the invention follow. Those systems and methods within computing that rely on a tags or tokenized features or sets of features will be greatly enhanced by this invention. This includes web media, mobile devices, information retrieval systems, knowledge discovery systems, and artificial intelligence. This invention allows items, objects, and articles, particularly those within web media, to be more quickly and effectively sorted and grouped. The invention allows for tags and features to be stored in a manner that allows them to be better and more effectively utilized for knowledge discovery and information retrieval. The invention allows for the creation of a smaller informational proxy element to represent larger data, collections and structures, speeding comparison and retrieval. The invention allows for the construction of an “archetype” comprised of descriptors, draws, and distances that serves to dimensionalize tags, making their use within a system faster and more effective. While dimensionalized tags can be stored as a bag-of-features, the preferred embodiment of the invention stores these tags in a kernel matrix that can be used to enact support vector machines for deeper knowledge discovery and comparison. A further benefit of the invention is the minimization of computing resources as a result of shared elements across a collection being re-tokenized as a single elements, replacing larger collections of elements—this results in less computing complexity at runtime. A further advantage of the invention is that the archetypes acting as proxies, can be shared across systems and platforms. The overarching advantage of the invention, is that information embodied in elements of the invention become self-aware of their context and use, allowing said elements to become self-organizing and knowledge discovery to be automated.

Further objects and advantages will become apparent from a consideration of the ensuing description.

### SUMMARY

This SYSTEM AND METHOD FOR KNOWLEDGE DISCOVERY, INFORMATION RETRIEVAL AND INFORMATION MANAGEMENT VIA TAG DIMENSIONALIZATION AND PROXY ARCHETYPES is comprised of a set of archetypes with each archetype being comprised of one or more “affinitomic” elements stored either as a kernel matrix or in such a way that they can construe a kernel matrix and one or more links or references to the real person, place, thing concept or construct that is represented by the archetype. An archetype may optionally include encoded affinitomics that represent a larger collection of affinitomic elements. An archetype may optionally include a payload that is delivered when a matching or selection criteria is met. The system is further comprised of a means and rules for evaluating the archetypes and assigning them a score based on similarities to a separate set of affinitomic elements—such means could include weighted sorts, support vector machines, probabilistic filters, or other means whereby one or more of the dimensionalized tags represented by the affinitomic elements are utilized to make a selection. The system is further comprised of a data store for the affinitomic archetypes such that they may be efficiently indexed and retrieved based on either distinct queries or threshold of match to a specific archetype. The system is optionally further comprised of a means to discover archetypes within a set or sets of matching affinitomic elements and encode these sets as a separate archetype referenced as a single affinitomic element. By this means the system can both minimize storage and nest affinitomic archetypes. The system is optionally further comprised of a means to discover affinitomics from a data source via such methods as language processing or feature extraction and automatically create archetypes that are representational of said data source. The system is optionally further comprised of a mechanism to infer or assign the domain or context within which an archetype is to be used, such as a tree, map or schema. The system is optionally further comprised of a means of encrypting archetypes and collections of archetypes such that they can be used, opened, or read only by those entities possessing appropriate keys.

### BRIEF DESCRIPTION OF SEVERAL VIEWS OF THE DRAWINGS

The embodiments of this invention are illustrated by way of example and not limitation in the figures of the accompanying drawings, in which like references indicate similar elements and in which:

FIG. 1.—Illustrates storage strategies for archetypes

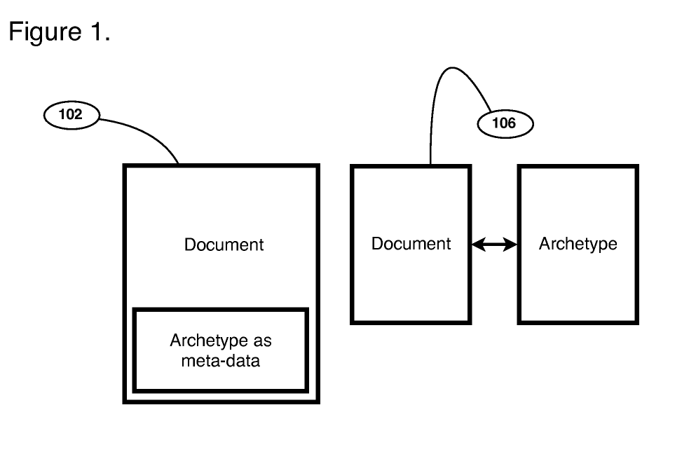

FIG. 2.—Illustrates archetype composition and elements of an archetype

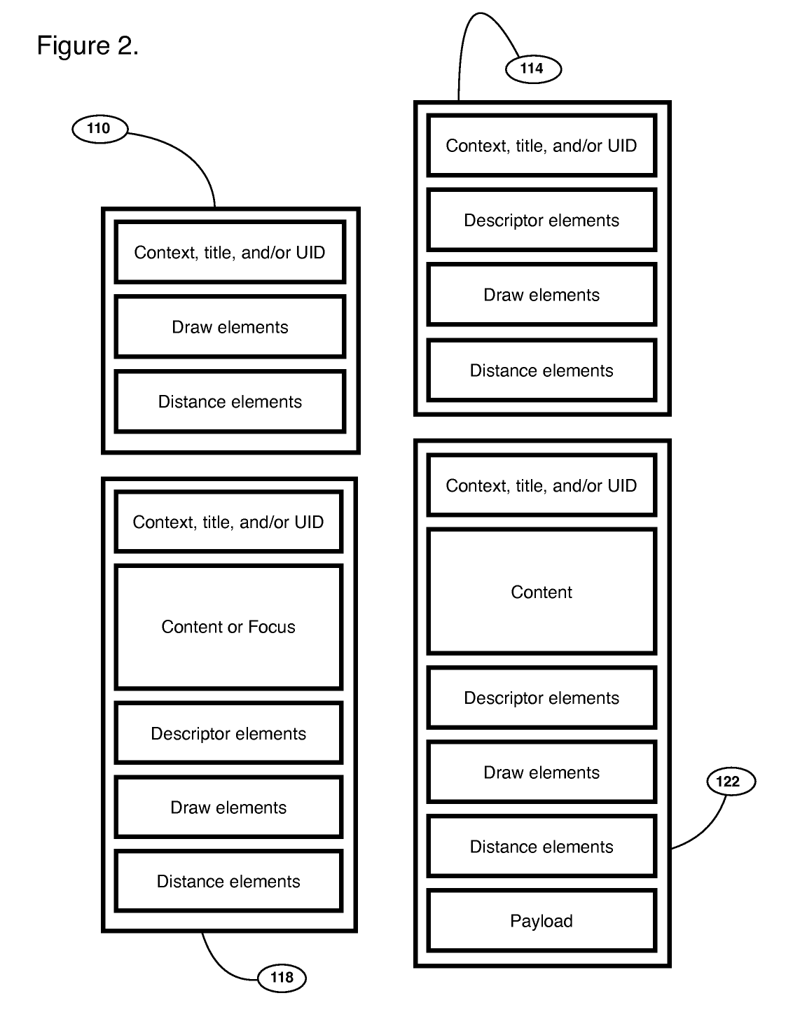

FIG. 3.—Illustrates processing archetypes for affinity

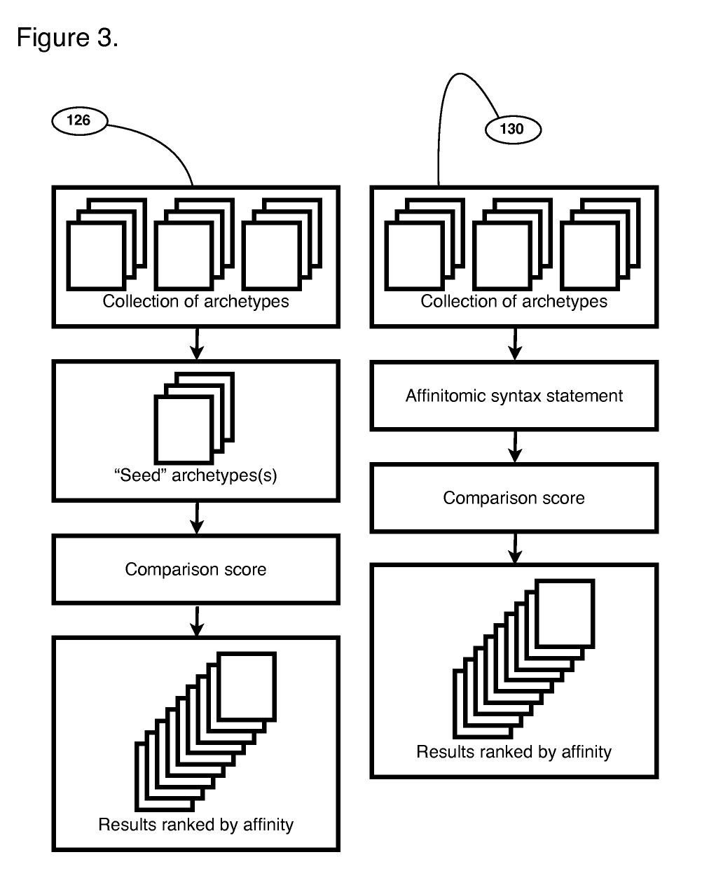

FIG. 4.—Illustrates kernel storage strategies for affinitomics

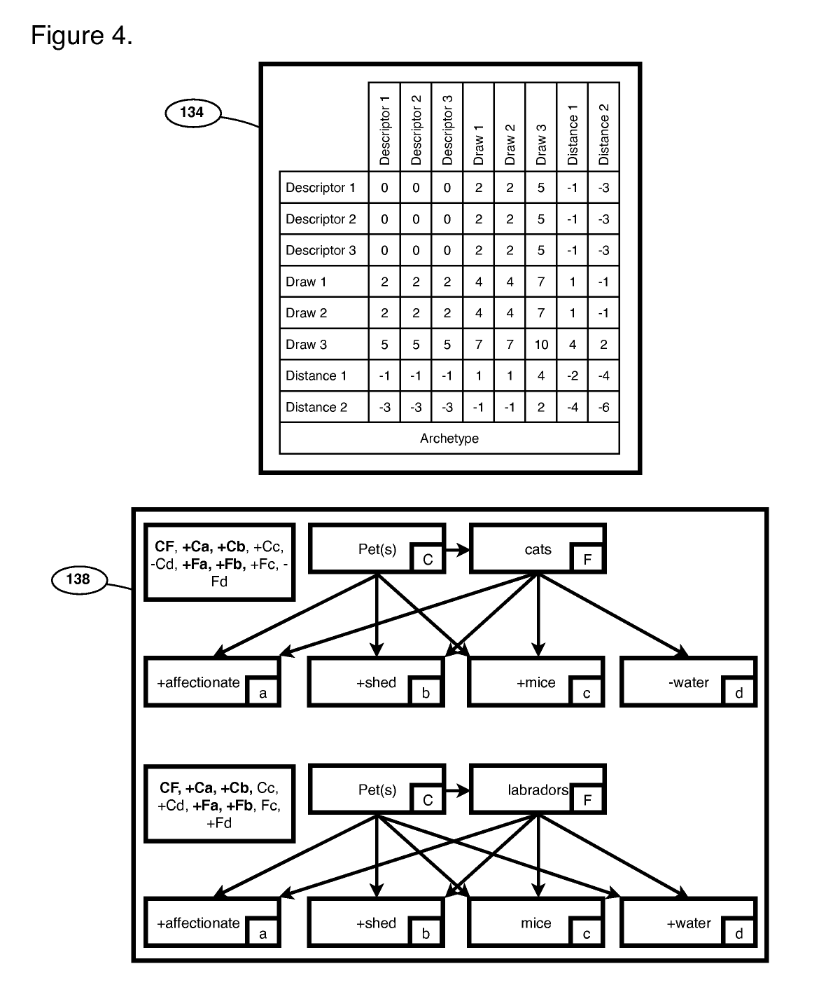

FIG. 5.—Illustrates encoding process for affinitomic elements

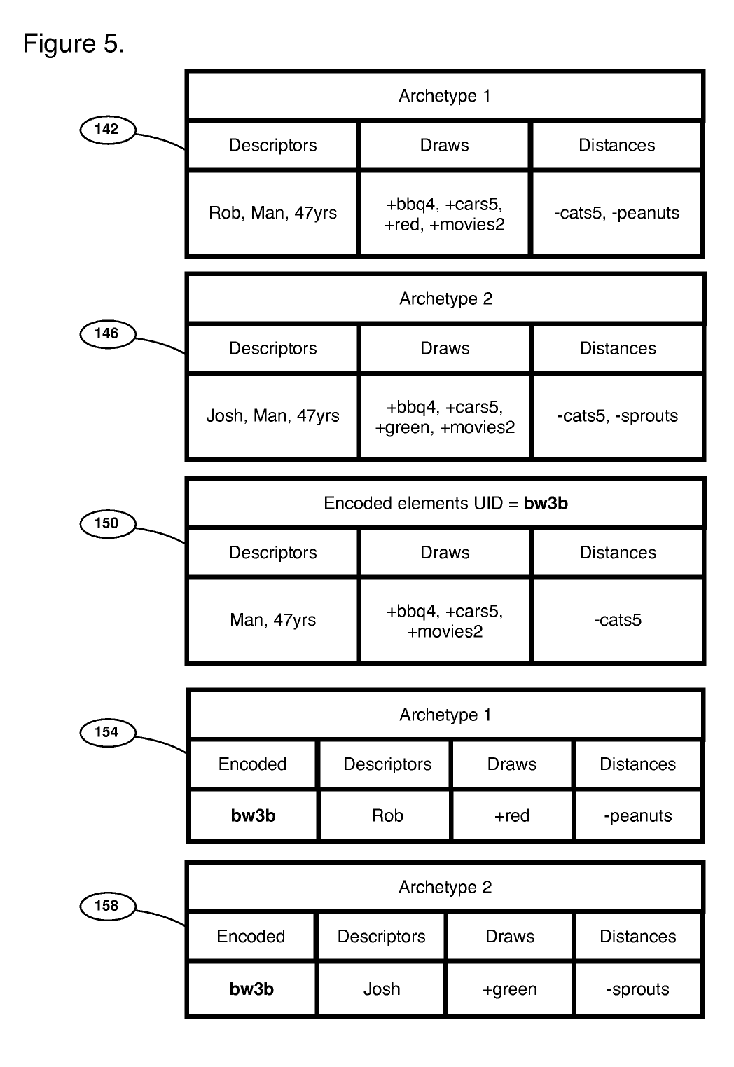

FIG. 6.—Illustrates storing multiple affinitomics as a summed kernel matrix

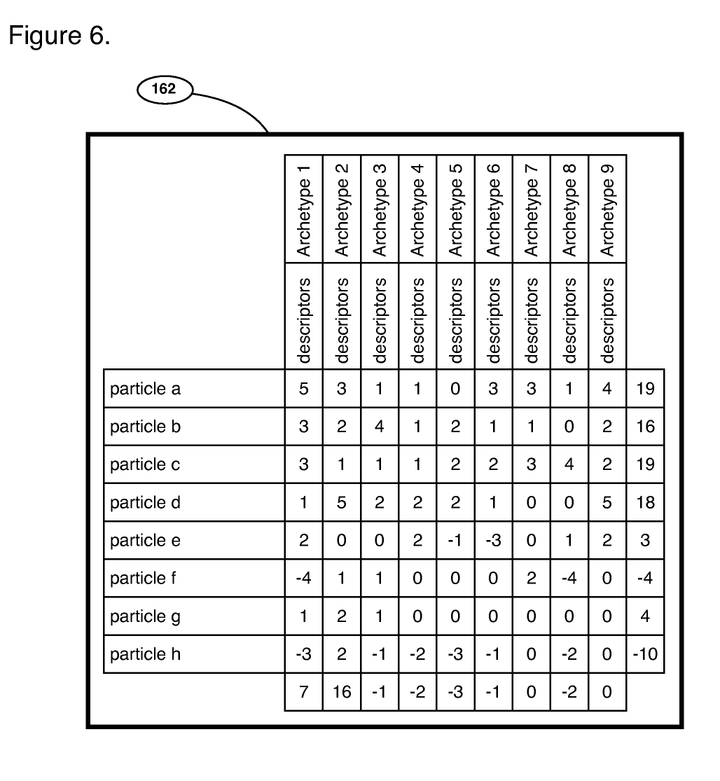

### DETAILED DESCRIPTION

For purposes of clarity, we define the following:
Affinitomics refers to the practice of utilizing individual tag elements consisting of descriptors (defined below), draws (defined below), and distances (defined below) or the application of these elements, to compare proxy archetypes within and across collections of archetypes for the purposes of knowledge discovery, information retrieval and information management. This comparison results in a value that represents an affinity or nearness.
Archetypes refer to a proxy representation of a real person, place, thing, concept or construct. Said proxy representation is minimally comprised of at least one instance of a descriptor, draw, or distance, and a link or reference to or description of the real person place thing, or concept being represented by the archetype.
Descriptor elements, or descriptors, or neutral particles are informational tags that describe characteristics of a person, place, thing, concept or construct. A descriptor is an affinitomic element.
Draw elements, or draws, or positive particles, are informational tags that connote an affinity to or toward a person, place thing, concept or construct. A draw is an affinitomic element.
Distance elements, or distances, or negative particles, are the opposite of Draws and connote an avoidance or predilection away from a person, place, thing, concept or construct. A distance is an affinitomic element.
Encoded element are comprised of two or more affinitomic elements that have been reduced and written as a single element within an affinitomic archetype
An affinitomic genome is a set or list of encoded affinitomic elements that reference a number of external archetypes as part of a tree, schema, or other structure that infers context or use.
Affinitomic payload or payload refers to information, data, or functions that are enacted when an archetype is matched or selected in a system.
Amplitude refers to a positive or negative value associated with an element, particle, draw or distance. In the preferred embodiment covered in this disclosure, it ranges from −5 to 5, but should not be construed as being limited to these values.
Summed kernel matrix refers to matrices used as kernels where the cells of the kernel are comprised of sums of one or more functions.

This SYSTEM AND METHOD FOR KNOWLEDGE DISCOVERY, INFORMATION RETRIEVAL AND INFORMATION MANAGEMENT VIA TAG DIMENSIONALIZATION AND PROXY ARCHETYPES is comprised of a set of archetypes with each archetype being comprised of one or more affinitomic elements stored either as a kernel matrix or in such a way that they can construe a kernel matrix and one or more links or references to the real person, place, thing concept or construct that is represented by the archetype. An archetype may optionally include encoded affinitomics that represent a larger collection of affinitomic elements. An archetype may optionally include a payload that is delivered when a matching or selection criteria is met.

The system is further comprised of a means and rules for evaluating the archetypes and assigning them a score based on similarities to a separate set of affinitomic elements—such means could include weighted sorts, support vector machines, probabilistic filters, or other means whereby one or more of the dimensionalized tags represented by the affinitomic elements are utilized to make a selection.

The system is further comprised of a data store for the affinitomic archetypes such that they may be efficiently indexed and retrieved based on either distinct queries or threshold of match to an specific archetype.

The system is optionally further comprised of a means to discover archetypes with a set or sets of matching affinitomic elements and encode these sets as a separate archetype referenced as a single affinitomic element. By this means the system can both minimize storage and nest affinitomic archetypes.

The system is optionally further comprised of a means to discover affinitomics from a data source via such methods as language processing or feature extraction and automatically create archetypes that are representational of said data source.

The system is optionally further comprised of a mechanism to infer or assign the domain or context within which an archetype is to be used, such as a tree, map or schema.

The system is optionally further comprised of a means of encrypting archetypes and collections of archetypes such that they can be used, opened, or read only by those entities possessing appropriate keys.

Archetypes are either constructed as 102 meta-data embedded into a document or 106 attached by some means to the data they represent, or they are discovered via a processing method that relies on some means of feature extraction. In the case of textual data, a language processing system would utilize an understanding of a syntax to extract affinitomic features. Such a syntax, its preferred embodiment, is described as having a nucleus consisting of one or more words, and various positive and negative particles ascribed to the nucleus.
The syntax for affinitomics adopts an atomic model. At its core is the affinitomic particle. The particle, in written affinitomic syntax is a word, or phrase preceded by a + (positive affinity), a − (negative affinity), or a +− (neutrality).

An affinitomic “atom” is comprised of a nucleus, and at least one particle.

If “skier” is our nucleus, possible particles, both positive and negative, might include +snow, +Sun Valley, −rain, +−sunshine. To construct the concept in natural language (for Affinitomic Parsing) A skier(s) likes snow, Sun Valley, no rain, and sometimes sunshine. In Affinitomic Syntax; Skier(s)] +snow, +SunValley, −rain, +−sunshine Notice that the nucleus is defined at the beginning of the statement with a close bracket].

A non-designated particle is treated as a tag or keyword. It designates it as a “sub-particle” with two uses—It can be used in search constructs to discern whether the affinitomic atom is relevant (a preponderance of such tags could be construed as more relevancy) and whether or not exploration should occur to determine the sub-particle's polarity, and classify it. In the definition of the nucleus, it's best to include the plural of the object. Sometimes the plural can't be defined by simply adding an (s). In which case; Goose(Geese).

Skier(s)] +snow, +SunValley, −rain, +−sunshine This is referred to as simple, or clean syntax. It contains a single concept in the nucleus, and only positive, negative, and neutral particles making it easy to parse, calculate, and index.

“Rob's family are mostly skiers”] +snow, +SunValley, −rain, +−sunshine—This affinitomic approach is “dirty” syntax in that it relies on computational elements or part-of-speech mechanics to determine values present in the nucleus.

Complex affinitomic syntax utilizes lists and taxonomies to reduce how many affinitomic atoms need to be constructed for a particular use. Complex list syntax defines a list of nuclear concepts or objects that share particles. Maddox, Rob, Tonya, William, Zade, Skier(s)] +snow, +SunValley, −rain, +−sunshine replaces . . .

Maddox] +snow, +SunValley, −rain, +−sunshine

Rob] +snow, +SunValley, −rain, +−sunshine

Tonya] +snow, +SunValley, −rain, +−sunshine

William] +snow, +SunValley, −rain, +−sunshine

Zade] +snow, +SunValley, −rain, +−sunshine

Skier(s)] +snow, +SunValley, −rain, +−sunshine

Looking more closely at the list in the nucleus, however, we can see a more efficient means to construct the affinitomic syntax that will yield a higher likelihood by giving the nucleus better definition. Since the real context of the particles is skiing and skiers, and all the people in Rob's family are skiers, the same atom could be written using a nuclear array Skier(s)} Maddox, Rob, Tonya, William, Zade] +snow, +SunValley, −rain, +−sunshine has more contextual depth, so it's more accurate.

To explain the use of taxonomies in the nucleus, let's return to the phrase or concept “Rob's family.” If we first define Rob's family as a taxonomy, we can use the taxonomy as a shortcut. To do this, we create a list of the people in Rob's family, and then give it the name “Rob's family.”

|Rob's family=Maddox, Rob, Tonya, William, Zade|

Once a taxonomy is defined, it can be used to contextually replace a list of individual names, like so; Skier(s)} Rob's family] +snow, +SunValley, −rain, +−sunshine, snowboarding.

Furthermore, taxonomies can be nested. In the example below, the families have all been defined as taxonomies. They now become nested in the “The Husts” taxonomy.

|The Husts=Rob's family, William's family, Josh's family|

Nested taxonomies can speed likelihood calculation by reducing ambiguity, and further defining context. Taxonomic exclusions extend this. To exclude an element of a Taxonomy we use ≠, as in the example.

Rob's family, ≠Rob] +peanuts, +walnuts, +cats

Taxonomies aren't only useful at the nucleus, but as particle elements as well. Exclusions in the particle space are simply negative particles. Holiday(s)} William's family] +Rob's family, −Rob.

Taxonomies, as either nuclear or particle elements aren't simply useful for reducing mark-up, but also as an evaluation shorthand or shortcut. In many instances, a rapid and “good enough” match can be made without diving into a lengthy taxonomy, especially a nested taxonomy.

To really understand the value of affinitomic syntax, it's important to understand how, and in what order, the information is parsed for affinities.
Context—since the value of the affinitomic match depends heavily on context, its the primary element that a body of information is parsed for, pluralization within parenthesis indicates that stemming should be applied:
Skier(s)} Rob's family] +snow, +SunValley, −rain, +−sunshine
Nuclear elements—since it is these elements that are essentially at the center of, or are the target of the match or discovery being performed. If elements are taxonomies, the parsing mechanism can descend into the taxonomies (or not). If the elements are lists, the parser can descend into the elements or not:
Skier(s)} Rob's family] −snow, −SunValley, −rain, +−sunshine
Particle Elements—particles describe the attraction or repulsion of the subject material (nucleus) to concepts or constructs. If elements are taxonomies, the parsing mechanism can descend into the taxonomies, or not. Positive, negative, neutral, and undefined particles are parsed and evaluated in the order that makes the most sense for their eventual application, this can be positive/negative concordance, a likelihood calculation, a matching algorithm, an FCA lattice or other such mechanism:
Skier(s)} Rob's family] +snow, +SunValley, −rain, +−sunshine
In the preferred embodiment, amplitude is assigned to an affinitomic element, positive or negative, by the value of the amplitude as a suffix to the element. This describes how important the element is to any ensuing analysis. +snow5 is five times more valuable within the system than +SunValley. Conversely, −rain5 indicates a distance five times greater than −rain. If an amplitude of a positive or negative element (draw or distance) is not present, it is considered to be 1 in the case of positive elements, and −1 in the case of negative elements. Neutral elements do not have amplitude.

While a syntax for describing an archetype is useful, it is not always practical. An archetype can be defined within a system by assigning it a name or title, ascribing descriptors, draws, and distances, and 102 either attaching it directly to a data type as meta-data, or 106 linking it to the data it represents by some means. 110 Minimally, an archetype must include at least a context, title or name, as well as at least one draw or distance. 114 Adding descriptors makes the archetype more useful by supplying greater means of analysis (more features). 118 The preferred embodiment is for the Archetype to include a context, name or UID, content describing the focus and use of the archetype (document body), one or more descriptor elements, one or more draw elements, and one or more distance elements. 122 Optionally, an archetype can include a payload of data, code fragments, hyperlinks, or any other useful construct. The payload is delivered if a selection or match is made when the archetype is evaluated. Archetypes can be further refined if given a context or schema that defines when and if they will be evaluated.

Evaluating Archetypes within the system is done by 126 comparing one or more seed archetypes to a plurality of archetypes or 130 by comparing a statement or query containing elements that comprise an archetype to a plurality of archetypes. The most simplistic comparison of archetypes calculates the magnitude of common affinitomic elements between an initiating archetype and a prospective archetype or collection of prospective archetypes as a sum. In a preferred embodiment, prospective archetypes would be gathered from a collection wherein the prospects shared one or more descriptors, and or one or more draws and or one or more distances. Commonalities between descriptors, draws, and distances add one to the sum. Amplitudes of matching elements above one are added to the sum as well. In the preferred embodiment, amplitudes are as high as five and as low as negative-five. The resulting score for each prospect compared to the initiating archetype determines the rank of the prospect. In cases where there are matching affinitomic distances, the negative amplitudes are converted to positive numbers in the preferred embodiment. The result of the comparison is a sorted list of prospect archetypes based on the score. The preferred embodiment of comparison for exceedingly large collections of complex archetypes, where a sorting algorithm is too computationally expensive, is to consider the affinitomic elements as one or more of various types of 134 138 kernel and apply various kernel methods to compare the archetypes.—in such a case, the resulting list would likely use probabilities as opposed to sums.

Encoding affinitomics is a useful way to reduce computational expense and archetype size. Encoded elements can be either evaluated directly as a singular element, or its constituent elements can be analyzed. Encoded elements are essentially affinitomic archetypes used as descriptors, draws, and or distances. These archetypes are comprised of affinitomic elements that occur as a pattern with great frequency amongst the pool of prospective archetypes. As an example, given 142 an archetype that has descriptors Rob, Man, 47 yrs; draws of +bbq4, +cars5, +red, +movies2; and distances −cats5, −peanuts—then given 146 an archetype that has descriptors Josh, Man, 47 yrs; draws +bbq4, +cars5, +green, +movies2; and distances of −cats5, −sprouts—it can be discerned that the descriptors of Man, 47 yrs; the draws of +bbq4, +cars5, +movies2; and the distance of −cats5 are held in common. For purposes of brevity and reducing complexity it is useful to create 150 an encoded archetype, or encoding element with a UID that contains these elements. Thereafter, 154 158 archetypes can refer to the encoded archetype instead of repeating the shared descriptors, draws, and distances. So a subsequent archetype with common descriptors, as well as common draws, and distances Can be reduced in size and complexity by using the encoded elements.

Discovery of archetypes from a corpus or sets of data is possible via a variety of language processing methods in the case of written text, or other feature extraction methods appropriate to the data being processed in the case of other data types. In the preferred embodiment, a language processing heuristic is employed that uses WordNet to facilitate part of speech, stemming, and synonym set detection as well as any one of a number of techniques for word sense disambiguation (both supervised or unsupervised) such that the predominate subjects become descriptors, nouns and verbs describing acts or actions that are popular in relationship to the subject(s) become draws, and negatively indicated actors or actions become distances. Because the affinitomics are stored such that they can be used as kernels, the new archetype can be recursively evaluated for fitness against current archetypes.

Archetypes are stored via a means that allows them to be easily read as kernel matrices. Each archetype can be read as a graph of either all elements within the archetype represented symmetrically along two axis or with descriptors along one axis and draws and distances along another. These matrices can 162 alternately be represented as graphs of the entire collection of archetypes, with values present for the individual archetype being represented. In the preferred embodiment, a matrix is stored for both the individual archetype, and the archetype within the collection. This allows for rapid sorting at run time, and affinity indexing for rapid information retrieval and caching.

Archetypes are either stored with, or linked to, the data they represent. For smaller collections of data is it appropriate to store affinitomics with or within the data they represent as meta-data since sorting and comparison is computationally inexpensive. For larger collections it is more appropriate for an affinitomic archetype to be linked to the data. Archetypes stored separately are, in the preferred embodiment compared to all other archetypes within the collection and indexed in such a manner as to reflect similarities between archetypes. This practice enables efficient indexing by various means, as well as caching of archetypes that are commonly retrieved.

1. What is claimed is a method and system for creating a representational proxy for a real person, place, thing, concept, or construct within a computer system where such proxy is used to store tag elements for measuring or inferring affinity, nearness, or likelihood:

2. The method and system of claim 1, wherein the tags are, syntactical, semantic, taxonomic or otherwise related to language.

3. The method and system of claim 1 wherein the tag elements represent features within data.

4. The method and system of claim 1 wherein the tag elements represent descriptors, draws, and or distances.

5. The method and system of claim 1 wherein the proxies are represented as or contain feature data appropriate for populating a kernel matrix.

6. The method and system of claim 1 wherein the elements of the system reside across multiple systems that communicate or evaluate proxy representations.

7. The method and system of claim 1 where the proxy representations are affinitomic archetypes.

8. What is claimed is a method and system for evaluating the contextual appropriateness of a plurality of representational proxies in comparison to one or more representational proxies based on a set or sets of features contained within the representational proxies that describe, infer and or define affinities within a context.

9. The method and system of claim 8 for evaluating the fitness or belonging of a plurality of representational proxies in comparison with one or more representational proxies based on a set or sets of features contained within the representational proxies that describe, infer and or define belonging to or within a set or group.

10. The method and system of claim 8 for evaluating whether a plurality of proxy representations and their fitness to a single proxy.

11. The method and system of claim 8 for evaluating psycho-demographic fitness within a group or set.

12. What is claimed is a method and system for dimensionalizing meta-data tags or tag elements such that they are ascribed an amplitude representational of their objective or subjective value within a collection.

13. The method and system of claim 12 wherein the value is inferred.

14. The method and system of claim 12 wherein the value is a variable or variables.

15. The method and system of claim 12 wherein the value is defined or controlled by a kernel function.

16. The method and system of claim 12 wherein the value of a given tag or tag elements is random.
